(19) United States
(12) Patent Application Publication
(10) Pub. No.: US 2026/0169184 A1
(43) Pub. Date: Jun. 18, 2026

(54) SYSTEM AND METHOD FOR ESTIMATING PRESENCE USING WIFI CSI DATA

(71) Applicant: Korea Electronics Technology Institute, Seongnam-si (KR)

(72) Inventors: Ki Woong KWON, Seoul (KR); Young Ho KIM, Incheon (KR); Seung Hyeon PARK, Yongin-si (KR); Young Min JOO, Yongin-si (KR)

(73) Assignee: Korea Electronics Technology Institute, Seongnam-si (KR)

(21) Appl. No.: 19/406,171

(22) Filed: Dec. 2, 2025

(30) Foreign Application Priority Data
Dec. 13, 2024 (KR) 10-2024-0186050

(51) Int. Cl. G01V 3/12

(52) U.S. Cl. CPC G01V 3/12

(57) ABSTRACT

Provided is a presence estimation method using Wi-Fi CSI data including: extracting, by a system, CSI data of Wi-Fi from data transmitted by a Wi-Fi AP; and training, by the system, a presence estimation model by using the extracted CSI data as training data. When estimating the presence, it is possible to reduce sensor installation costs by using CSI data extracted from data packets transmitted by and collected from a Wi-Fi AP already installed, without installing additional sensors.

### CROSS-REFERENCE TO RELATED APPLICATION(S) AND CLAIM OF PRIORITY

This application is based on and claims priority under 35 U.S.C. § 119 to Korean Patent Application No. 10-2024-0186050, filed on Dec. 13, 2024, in the Korean Intellectual Property Office, the disclosure of which is herein incorporated by reference in its entirety.

### BACKGROUND

### Field

The disclosure relates to a system and a method for estimating presence, and more particularly, to a system and a method for estimating presence using Wi-Fi channel state information (CSI) data.

### Description of Related Art

To reduce energy waste, it is effective to automatically shut down energy instruments in the absence of people in buildings.

Typically, additional sensors are installed to determine presence/absence, but high-priced sensors may increase the installation costs, and low-priced presence sensors (infrared and microwave sensors) may have low accuracy and limited range in determining.

To reduce the installation costs of these sensors, technologies have been developed to determine presence/absence using equipment (CCTV) already installed in buildings, but in particular, video-based presence estimation technologies using CCTV may provide high accuracy but are limited in practical use due to infringement of personal data.

### SUMMARY

The disclosure has been developed in order to solve the above-described problems, and an object of the disclosure is to provide a system and a method for estimating presence in a building without installing additional sensors, which collect data packets transmitted by a Wi-Fi access point (AP) already installed, analyze CIS data extracted at a receiving device, and establish an AI model for estimating presence, and apply the AI model to a real environment to estimate presence.

According to an embodiment of the disclosure to achieve the above-described object, a presence estimation method using Wi-Fi CSI data may include: extracting, by a system, CSI data of Wi-Fi from data transmitted by a Wi-Fi AP; and training, by the system, a presence estimation model by using the extracted CSI data as training data.

In addition, the CSI data may include information on signal amplitudes, phases, and time of channels.

Extracting the data may include: calculating predetermined time-based variance values on the signal amplitudes and the phases included in each data sub-carrier of the CSI data; and averaging the predetermined time-based variance values of all data sub-carriers, and storing the average value.

The training data for the presence estimation model may include information on the predetermined time-based variance average of the CSI data, time, holidays, and actual presence or absence.

The information on the time which is included in the training data for the presence estimation model may indicate a time that is expressed by vectors, resulting from vectorization of time values expressed by scalars in order to effectively express a relationship between time.

In addition, the presence estimation model may be a model that uses at least one of logistic regression and a multi-layer perceptron (MLP).

In addition, the logistic regression may be a machine learning model that performs binary classification based on a given input parameter, and provides a probability of belonging to a specific class as an output value, and, when using the logistic regression as a single model, the presence estimation model may estimate a presence state if the probability is greater than or equal to 0.5, and may estimate an absence state if the probability is less than 0.5.

The MLP may be an artificial neural network structure that has one or more hidden layers, and an output layer may be comprised of one neuron, an activation function of the hidden layer may be a ReLU function, and an activation function of the output layer may be a sigmoid function that outputs a value between 0 and 1, and, when using the MLP as a single model, the presence estimation model may estimate a presence state if the output value is greater than or equal to 0.5 and may estimate an absence state if the output value is less than 0.5.

When the presence estimation model is a stacking-based ensemble model which uses logistic regression and an MLP, the presence estimation model may receive output values from the logistic regression and the MLP as input, and may output the presence or absence as output in order to make an ensemble of the logistic regression and the MLP, and the meta model may be an MLP that is comprised of one or more hidden layers and an output layer which is a single entity, an activation function of the hidden layer of the meta model may be a ReLU function, and an activation function of the output layer of the meta model may be a sigmoid function that outputs a value between 0 and 1, and the meta model may estimate a presence state if a value finally outputted through the meta model is greater than or equal to 0.5, and may estimate an absence state if the output value is less than 0.5.

According to another embodiment of the disclosure, there is provided a presence estimation system using Wi-Fi CSI data including: a CSI data extraction unit configured to extract CSI data of Wi-Fi from data transmitted by a Wi-Fi AP; and a model training unit configured to train a presence estimation model by using the extracted CSI data as training data.

According to still another embodiment of the disclosure, there is provided a presence estimation method using Wi-Fi CSI data including: extracting, by a system, CSI data of Wi-Fi from data transmitted by a Wi-Fi AP; and estimating, by the system, presence or absence by using the extracted CSI data as input data for a trained presence estimation model.

As described above, according to embodiments of the disclosure, when estimating the presence, it is possible to reduce sensor installation costs by using CSI data extracted from data packets transmitted by and collected from a Wi-Fi AP already installed, without installing additional sensors, and higher accuracy may be expected compared to low-priced presence sensors.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view provided to explain a system for estimating presence using Wi-Fi CSI data according to an embodiment of the disclosure;

FIG. 2 is a view provided to explain Wi-Fi CSI data;

FIG. 3 is a view provided to explain Wi-Fi CSI data;

FIG. 4 is a view provided to explain a more detailed configuration of a processor according to an embodiment of the disclosure;

FIG. 5 is a view provided to explain a step of collecting and storing Wi-Fi CSI data according to an embodiment of the disclosure;

FIG. 6 is a view provided to explain a method for estimating presence using Wi-Fi CSI data according to an embodiment of the disclosure; and

FIG. 7 is a view provided to explain an ensemble-based presence estimation model according to an embodiment.

### DETAILED DESCRIPTION

Hereinafter, the disclosure will be described in more detail with reference to the accompanying drawings. In order to clearly explain the disclosure, parts not related to the descriptions are omitted from the drawings, and, in the drawings, the width, lengths, thicknesses of components may be exaggerated for convenience.

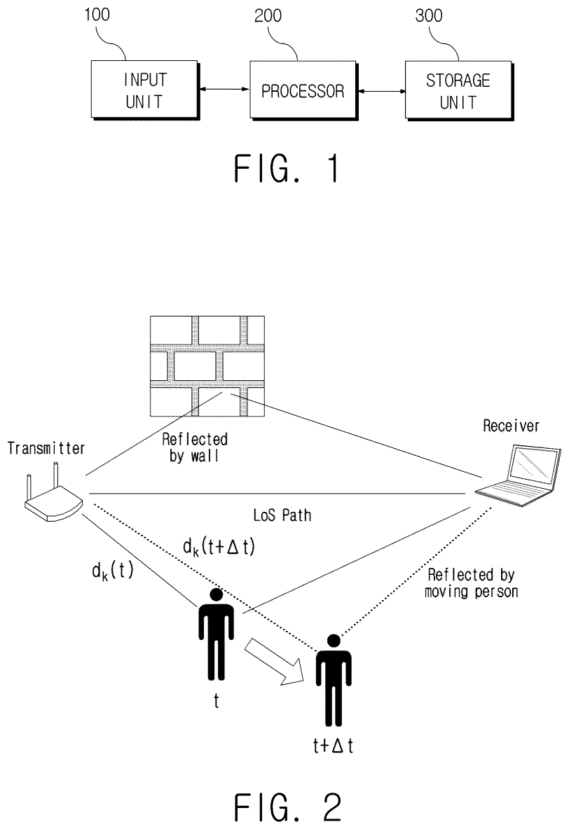

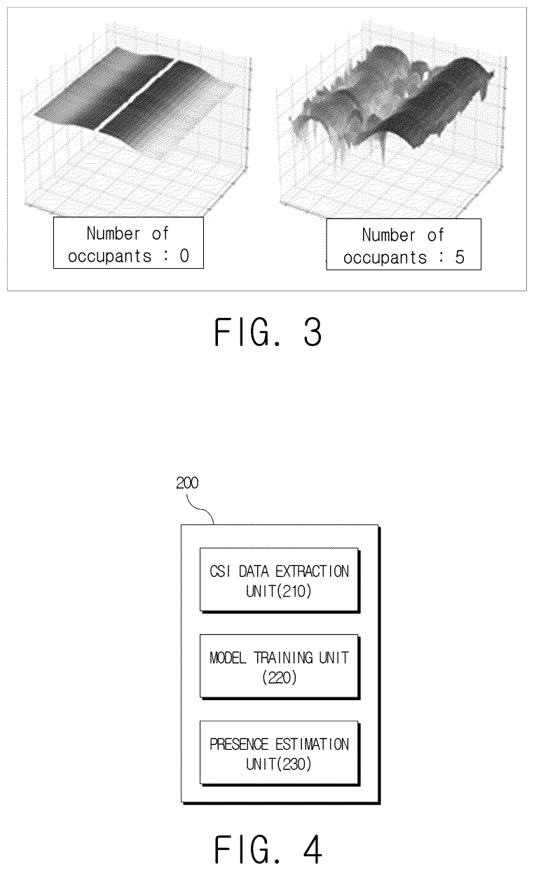

FIG. 1 is a view provided to explain a system for estimating presence using Wi-Fi CSI data according to an embodiment of the disclosure, FIG. 2 is a view provided to explain Wi-Fi CSI data, and FIG. 3 is a view provided to explain Wi-Fi CSI data.

The system for estimating presence using Wi-Fi CSI data (hereinafter, referred to as a ‘system’) according to an embodiment is provided to estimate presence in a building, without installing additional sensors, by collecting data packets transmitted by a Wi-Fi AP already installed, and analyzing CSI data extracted by a receiving device.

To achieve this, the system may include a communication unit 100, a processor 200, and a storage unit 300.

The communication unit 100 may be provided with a communication module connected to a network to acquire data transmitted by a Wi-Fi AP.

Wi-Fi CSI is data that provides detailed information on a propagation state of Wi-Fi signals, and may include changes in signal amplitudes, phases, and change in time of channels.

Based on this information, various phenomena occurring in a Wi-Fi network may be analyzed.

When there are movements of an occupant, signal amplitudes and phases of Wi-Fi CSI are more greatly changed, and hence, by analyzing changes, the presence may be estimated.

When an occupant moves over time as shown in FIG. 2, changes in signal amplitudes of Wi-Fi CSI may occur over time as shown in FIG. 3.

The left drawing of FIG. 3 illustrates a case in which there is no occupant, and the right drawing of FIG. 3 illustrates a case in which there are occupants (for example, 5 occupants). Comparing the two drawings, changes in signal amplitudes when there are occupants are greater than when there is no occupant.

The storage unit 300 is provided to store programs and data necessary for operations of the processor 200.

The processor 200 may process overall operations to estimate presence in a building.

Specifically, the processor 200 may extract Wi-Fi CSI data from data packets transmitted by a Wi-Fi AP, and may train a presence estimation model by using the extracted CSI data as training data.

In addition, the processor 200 may estimate the presence by using the extracted CSI data as input data for the trained presence estimation model.

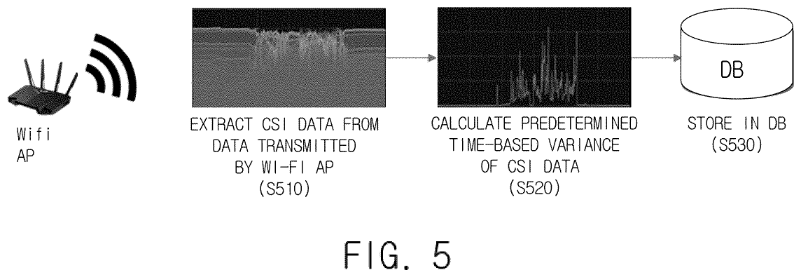

FIG. 4 is a view provided to explain a more detailed configuration of the processor 200 according to an embodiment of the disclosure, and FIG. 5 is a view provided to explain a step of collecting and storing Wi-Fi CSI data according to an embodiment of the disclosure.

Referring to FIG. 4, the processor 200 may include a CSI data extraction unit 210, a model training unit 220, and a presence estimation unit 230.

The CSI data extraction unit 210 may extract Wi-Fi CSI data from data packets transmitted by a Wi-Fi AP.

Specifically, Wi-Fi CSI may be collected through an open source called Nexmon CSI. Nexmon CSI supports Rasberry Pi, smartphones, routers, etc., and the CSI data extraction unit 210 may extract CSI data of a Wi-Fi AP that is targeted by using Nexmon CSI as shown in FIG. 5 (S510).

In this case, the number of sub-carriers of Wi-Fi CSI depends on Wi-Fi standards and channel bandwidths used in the Wi-Fi AP, and each sub-carrier includes an amplitude and a phase. The sub-carriers may be divided into guard sub-carriers, direct current (DC) sub-carriers, and data sub-carriers. The guard sub-carriers and the DC sub-carriers are not used for transmitting data, such that the CSI data extraction unit 210 may disregard DC sub-carriers and guard sub-carriers and may only use data sub-carrier when analyzing CSI data.

For example, a channel of 802.11n/802.11ac 20 MHz is comprised of 64 sub-carriers, and the CSI data extraction unit 210 does not use one DC sub-carrier in the middle (zeroth) and 7 guard sub-carriers (−32^{nd}˜29^{th}, +29^{th}˜+31^{st}) on both sides of the DC sub-carrier, and uses only the remaining 56 data sub-carriers (−28^{th}˜1^{st}, +1^{st}˜+28^{th}).

Specifically, the CSI data extraction unit 210 may calculate predetermined time-based variance values on the signal amplitude and the phase included in each data sub-carrier of the CSI data (S520), and may average the predetermined time-based variance values of all data sub-carriers and may store the corresponding average value in a database (DB) of the storage unit 300 (S530).

For example, the CSI data extraction unit 210 may calculate variance values for the amplitude and the phase included in each data sub-carrier every 5 minutes, and then, may average the variance values of all data sub-carriers and may store the corresponding average value in the database DB of the storage unit 300.

A variance is a value indicating the degree of change in data, and a variance value increases if data is greatly changed for 5 minutes and is close to 0 if there is no change in data.

Accordingly, when the variance value is great, it may be determined that occupants are present, and, when the variance value is close to 0, it may be determined that there is no occupant.

The time interval used for calculating variance values is set to 5 minutes in the disclosure, but may be flexibly adjusted according to a situation on site. In order to improve the accuracy of the presence estimation model, it is important to set an appropriate time unit (interval) for the site.

The model training unit 220 may train the presence estimation model by using the extracted CSI data as training data.

Specifically, the model training unit 220 may train the presence estimation model by using data including information on a predetermined time-based variance average of CSI data (for example, 5-minute-based variance average), time, holidays, and actual presence, as training data for the presence estimation model. In this case, the presence/absence (absence: 0, presence: 1) may be an output value from the estimation model.

Information on the time that is included in the training data for the presence estimation model may indicate a time that is expressed by vectors, resulting from vectorization of a time value expressed by scalars in order to effectively express a relationship between time.

Specifically, when a time expressed by scalars is vectorized and is used in the form of (x, y), a relationship between time may be better expressed.

For example, when 23 o'clock and 0 o'clock are compared based on scalars and a maximum difference (24 hours) between the scalar time values is set to 1, there occurs a difference of about 0.96 (that is, (23−0)/24≈0.96). However, when 23 o'clock and 0 o'clock are compared based on

vectors, 23 o'clock may be expressed by (−0.26, 0, 97) and 0 o'clock may be expressed by (0, 1), and a distance between the two vectors is about 0.26. Therefore, when a maximum difference (a diameter of a circle: 2) between the vector time values is set to 1, there occurs a different of about 0.13 (that is, 0.26/2≈0.13).

In fact, the similarity may be determined to be high because 23 o'clock and 0 o'clock have a one-hour difference. However, when they are expressed by scalars, a difference of about 0.83 occurs more than when they are expressed by vectors. Therefore, vectorizing time may be more advantageous to increase the accuracy of a model.

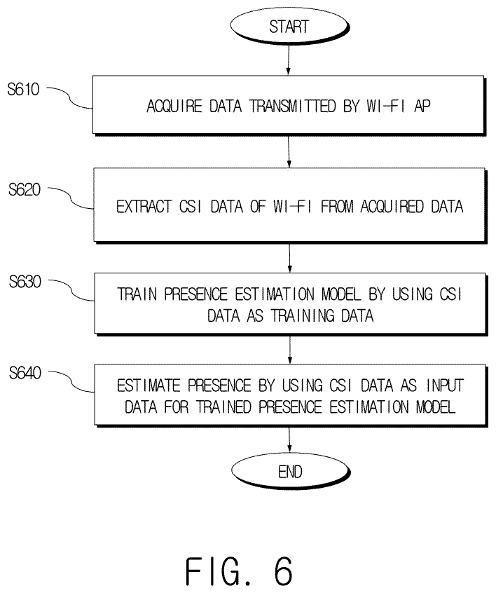

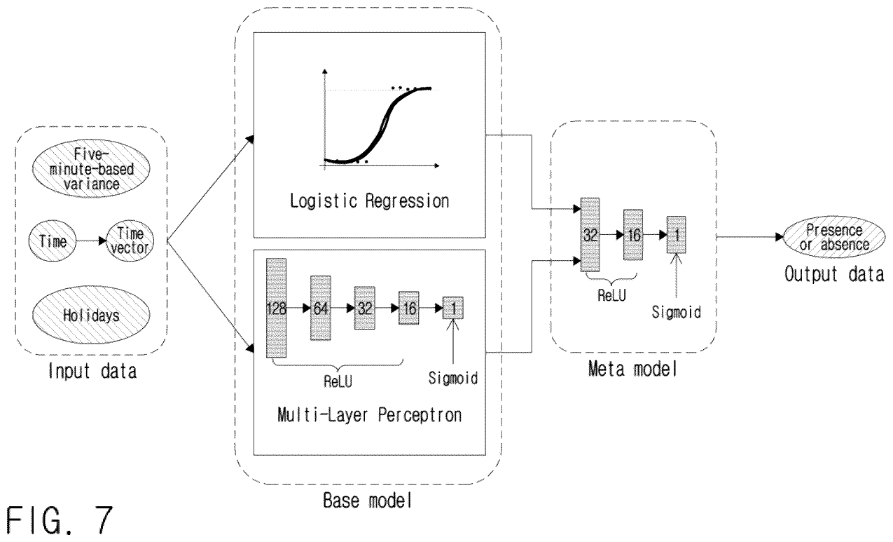

The presence estimation unit 230 may estimate the presence by using the extracted CSI data as input data for the trained presence estimation model. The presence estimation model will be described in detail below with reference to FIGS. 6 to 7.

FIG. 6 is a view provided to explain a presence estimation method using Wi-Fi CSI data according to an embodiment of the disclosure, and FIG. 7 is a view provided to explain an ensemble-based presence estimation model according to an embodiment of the disclosure.

The presence estimation method using Wi-Fi CSI data according to an embodiment may be executed by the system described above with reference to FIGS. 1, 2, 3, 4, 5.

Referring to FIG. 6, when the system acquires data transmitted by a Wi-Fi AP (S610), the system may extract CSI data of Wi-Fi from the acquired data (S620), and may train a presence estimation model by using the extracted CSI data as training data (S630).

Here, the data used as training data may be data that includes information on a predetermined time-based variance average of CSI data (for example, a 5-minute-based variance average), time, holidays, and actual presence.

The system may estimate the presence by using the extracted CSI data as input data for the trained presence estimation model (S640). Here, the input data for the trained presence estimation model may be data about a predetermined time-based variance average of CSI data (for example, a 5-minute-based variance average), time, holidays.

In this case, the presence estimation model may be a model that uses at least one of logistic regression and a multi-layer perceptron (MLP).

For example, the presence estimation model may be a stacking-based ensemble model that uses logistic regression and a MLP as shown in FIG. 7.

That is, the presence estimation model may use data on a predetermined time-based variance average (for example, 5-minute-based variance average) of CSI data, time, holidays as input data, and may be configured with a base model that includes logistic regression and an MLP, and a meta model that uses output data from the logistic regression and the MLP as input data.

Logistic regression is a machine learning model that performs binary classification based on a given input parameter, and provides a probability of belonging to a specific class (for example, a presence state or an absence state), and, when the presence estimation model uses logistic regression as a single model, the present estimation model may estimate a presence state if the probability is greater than or equal to 0.5, and may estimate an absence state if the probability is less than 0.5.

An MLP is an artificial neural network structure having one or more hidden layers, and an output layer is comprised of one neuron, an activation function of the hidden layer is a ReLU function and an activation function of the output layer is a sigmoid function that outputs a value between 0 and 1.

For example, the MLP may be comprised of four hidden layers, and each hidden layer may be comprised of 128, 64, 32, 16 neurons.

In this case, when the presence estimation model uses the MLP as a single model, the presence estimation model may estimate a presence state if the output value is greater than or equal to 0.5 and may estimate an absence state if the output value is less than 0.5.

In addition, when the presence estimation model is a stacking-based ensemble model that uses logistic regression and an MLP, the presence estimation model may generate a meta model that receives the output values from the logistic regression and the MLP as input, and outputs the presence/absence in order to make an ensemble of the logistic regression and the MLP.

In this case, the meta model is a multi-layer perceptron comprised of one or more hidden layers and an output layer which is a single entity, and an activation function of the hidden layer of the meta model may be a ReLU model, and an activation function of the output layer of the meta model may be a sigmoid function that outputs a value between 0 and 1.

For example, the meta model may be comprised of two hidden layers and one output layer, and the number of neurons of each hidden layer may be 32, 16.

In this case, the meta model may estimate a presence state if the value finally outputted through the meta model is greater than or equal to 0.5, and may estimate an absence state if the output value is less than 0.5.

In another example, the presence estimation model may average the result of estimating by the logistic regression and the result of estimating by the MLP by using the logistic regression and the MLP, and may estimate a presence state if the average is greater than or equal to 0.5 and may estimate an absence state if the average is less than 0.5.

The presence estimation model that is developed by learning the 5-minute-based variance average of Wi-Fi CSI, time, holidays, presence data may be used for estimating the presence/absence of the present time.

Wi-Fi CSI values for the period starting from 5 minutes before the current time to the current time may be read from the database DB of the storage unit 300, and an average of 5-minute-based variances of all sub-carriers may be calculated, and a current scalar time may be vectorized and may be inputted to the estimation model along with holiday information.

The presence estimation model may output a value between 0 and 1, and determines a presence state if the output value is greater than or equal to 0.5 and determines an absence state if the output value is less than 0.5.

The presence estimation model may contribute to energy consumption reduction by shutting off in association with an energy management system when energy devices are turned on in an absence state.

Up to now, the system and method for estimating presence using Wi-Fi CSI data has been described in detail with reference to preferred embodiments.

According to embodiments of the disclosure, when estimating the presence, it is possible to reduce sensor installation costs by using CSI data extracted from data packets transmitted by and collected from a Wi-Fi AP already installed, without installing additional sensors, and higher accuracy may be expected compared to low-priced presence sensors.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A presence estimation method using Wi-Fi CSI data, the method comprising:
extracting, by a system, CSI data of Wi-Fi from data transmitted by a Wi-Fi AP; and
training, by the system, a presence estimation model by using the extracted CSI data as training data.

2. The presence estimation method of claim 1, wherein the CSI data comprises information on signal amplitudes, phases, and time of channels.

3. The presence estimation method of claim 2, wherein extracting the data comprises:
calculating predetermined time-based variance values on the signal amplitudes and the phases included in each data sub-carrier of the CSI data; and
averaging the predetermined time-based variance values of all data sub-carriers, and storing the average value.

4. The presence estimation method of claim 3, wherein the training data for the presence estimation model comprises information on the predetermined time-based variance average of the CSI data, time, holidays, and actual presence or absence.

5. The presence estimation method of claim 4, wherein the information on the time which is included in the training data for the presence estimation model indicates a time that is expressed by vectors, resulting from vectorization of time values expressed by scalars in order to effectively express a relationship between time.

6. The presence estimation method of claim 4, wherein the presence estimation model is a model that uses at least one of logistic regression and a multi-layer perceptron (MLP).

7. The presence estimation method of claim 6, wherein the logistic regression is a machine learning model that performs binary classification based on a given input parameter, and provides a probability of belonging to a specific class as an output value, and
wherein, when using the logistic regression as a single model, the presence estimation model is configured to estimate a presence state if the probability is greater than or equal to 0.5, and to estimate an absence state if the probability is less than 0.5.

8. The presence estimation method of claim 6, wherein the MLP is an artificial neural network structure that has one or more hidden layers, and an output layer is comprised of one neuron,
wherein an activation function of the hidden layer is a ReLU function, and an activation function of the output layer is a sigmoid function that outputs a value between 0 and 1,
wherein, when using the MLP as a single model, the presence estimation model is configured to estimate a presence state if the output value is greater than or equal to 0.5 and to estimate an absence state if the output value is less than 0.5.

9. The presence estimation method of claim 6, wherein, when the presence estimation model is a stacking-based ensemble model which uses logistic regression and an MLP, the presence estimation model is configured to receive output values from the logistic regression and the MLP as input, and to output the presence or absence as output in order to make an ensemble of the logistic regression and the MLP,
wherein the meta model is an MLP that is comprised of one or more hidden layers and an output layer which is a single entity,
wherein an activation function of the hidden layer of the meta model is a ReLU function,
wherein an activation function of the output layer of the meta model is a sigmoid function that outputs a value between 0 and 1,
wherein the meta model is configured to estimate a presence state if a value finally outputted through the meta model is greater than or equal to 0.5, and to estimate an absence state if the output value is less than 0.5.

10. A presence estimation system using Wi-Fi CSI data, the system comprising:
a CSI data extraction unit configured to extract CSI data of Wi-Fi from data transmitted by a Wi-Fi AP; and
a model training unit configured to train a presence estimation model by using the extracted CSI data as training data.

11. A presence estimation method using Wi-Fi CSI data, the method comprising:
extracting, by a system, CSI data of Wi-Fi from data transmitted by a Wi-Fi AP; and
estimating, by the system, presence or absence by using the extracted CSI data as input data for a trained presence estimation model.
